(19) United States
(12) Patent Application Publication
(10) Pub. No.: US 2013/0027846 A1
(43) Pub. Date: Jan. 31, 2013

(54) ELECTROLYTIC CAPACITOR AND METHOD FOR MANUFACTURING ELECTROLYTIC CAPACITOR

(71) Applicants: Hirotugu Ashino, Tokyo (JP); Tsutomu Tanji, Tokyo (JP)

(72) Inventors: Hirotugu Ashino, Tokyo (JP); Tsutomu Tanji, Tokyo (JP)

(73) Assignee: NIPPON CHEMI-CON CORPORATION, Tokyo (JP)

(21) Appl. No.: 13/641,062

(22) PCT Filed: Apr. 14, 2010
(86) PCT No.: PCT/JP2010/056685

§ 371 Date: Oct. 12, 2012

(51) Int. Cl. H01G 9/08; H01G 9/06

(52) U.S. Cl. 361/519; 29/25.03

(57) ABSTRACT

The present invention provides an electrolytic capacitor which is increased in vibration resistance by making it possible to fix the capacitor element strongly in the outer case, without adversely affecting electrical characteristics of the capacitor element. In an electrolytic capacitor in which a capacitor element obtained by winding electrode foils with a separator therebetween and winding a winding stop tape on an outer circumferential surface thereof to stop the winding is inserted in an outer case and the outer case is sealed with a sealing member, a width of the winding stop tape is greater than or equal to a width of the electrode foils, and the capacitor element is press-fixed by an internal bottom surface of the outer case and the sealing member.

### TECHNICAL FIELD

The present invention relates to an electrolytic capacitor and a method for manufacturing an electrolytic capacitor.

### BACKGROUND ART

Conventional electrolytic capacitors are configured as follows. A capacitor element is formed by winding an anode foil and a cathode foil with separators (made of insulative paper or the like) sandwiched therebetween, in which the anode foil is obtained by forming chemical conversion coatings on an etching foil which is made of a valve metal such as aluminum, and the cathode foil includes an etching foil of a valve metal such as aluminum. The capacitor element is impregnated with a drive electrolyte solution and housed in a metal outer case which is shaped like a closed-bottom cylinder. An open end portion of the outer case is sealed by a sealing member.

As for such electrolytic capacitors, Patent document 1 discloses a conventional method for fixing the capacitor element in the outer case. In this method, the capacitor element is fixed in the outer case by filling the inside space of the outer case with a fixing agent such as a thermoplastic resin, an epoxy resin, or the like.

Patent document 2 discloses that twisting of the capacitor element in the outer case is prevented by covering top and bottom portions of the capacitor element with insulating caps having a projection and engaging the insulating caps with respective recesses that are formed in the outer case.

Furthermore, as shown in FIG. 5, Patent document 3 discloses that a capacitor element 21 is fixed in an outer case by inserting a honeycomb-shaped fixing member 23 between the end surface of the capacitor element 21 and the internal bottom surface of the outer case 22.

### BACKGROUND ART DOCUMENTS

### Patent Document

Patent document 1: JP-UM-A-54-183660
Patent document 2: JP-A-53-46657
Patent document 3: JP-UM-A-59-132632

### SUMMARY OF THE INVENTION

### Problems that the Invention is to Solve

Incidentally, in recent years, electrolytic capacitors have come to be used for vehicles. In the vehicular use, the electrolytic capacitor continues to receive strong vibration that results from vibration produced by contact with the road surface while the vehicle is running, vibration due to engine rotations, and other kinds of vibration. Acceleration of several ten Gs (G: gravitational acceleration) or more may be imposed on electrolytic capacitors so as to serve as vibratory stress. The vibratory stress causes the capacitor element housed in the electrolytic capacitor to vibrate, possibly resulting in breaking of a lead terminal. Therefore, it is necessary that the capacitor element be fixed in the outer case by such a method as to endure such vibratory stress.

In the conventional method of fixing the capacitor element by filling the inside space of the outer case with a fixing agent such as resin (Patent document 1), a large amount of fixing agent needs to be charged in the outer case. As a result, that space inside the outer case which allows for increase in internal pressure while the electrolytic capacitor is used is so small that a safety device such as a pressure valve is activated easily. This means a problem that the life of the electrolytic capacitor is shortened.

As shown in Patent document 2, in the case of the structure that the capacitor element is held in the outer case by covering the top and bottom portions of the capacitor element with the insulating caps, to fix the capacitor element strongly, it is necessary that the capacitor element, the insulating caps and the outer case be engaged with each other accurately with no gaps. This requires an additional step in assembling the capacitor and hence makes the electrolytic capacitor expensive.

Furthermore, as shown in Patent document 3, in the method of fixing the capacitor element by inserting the honeycomb-shaped fixing member between the end surface of the capacitor element and internal bottom surface of the outer case, if the capacitor element is pressed strongly against the honeycomb-shaped fixing member, the end surface of the capacitor element may be damaged to render the electrode foils prone to be short-circuited with each other. Therefore, it is not allowable to impose strong pressing force on the capacitor element. This sets a limit in increasing the vibration resistance of the electrolytic capacitor.

In the case where strong fixing is necessary as in the case of the vehicular use etc., it is conceivable to press the capacitor element strongly from above and below. However, when a prescribed pressure is applied to the capacitor element, that part of the outer circumferential surface of the capacitor element which is not covered with the winding stop tape bulges out if the winding stop tape is narrow. If the capacitor element bulges out, unwinding occurs and the interval between the anode foil and the cathode foil is increased. This adversely affects the electrical characteristics of the electrolytic capacitor. For the above reason, the capacitor element cannot be press-fixed in the outer case by applying a prescribed pressure to the capacitor element.

The present invention has been proposed to solve the above-described problems in the art, and an object of the present invention is therefore to provide an electrolytic capacitor which is increased in vibration resistance as well as a manufacturing method of such an electrolytic capacitor by making it possible to fix the capacitor element strongly in the outer case without causing a short-circuit failure in the electrolytic capacitor or adversely affecting its electrical characteristics.

### Means for Solving the Problems

To attain the above object, according to the invention, in an electrolytic capacitor in which a capacitor element obtained by winding electrode foils with a separator therebetween and winding a winding stop tape on an outer circumferential surface thereof to stop the winding is inserted in an outer case, and the outer case is sealed by a sealing member, a width of the winding stop tape is greater than or equal to a width of the electrode foils, and the capacitor element is press-fixed by an internal bottom surface of the outer case and the sealing member.

With this configuration, in the winding-type electrolytic capacitor, since the capacitor element is winding-stopped and fixed by the winding stop tape whose width is greater than or equal to the width of the electrode foils, the capacitor element does not bulge out or unwind even if the capacitor element is pressed at a prescribed pressure in the outer case. Therefore, the capacitor element can be press-fixed by applying a prescribed pressure to it. As a result, the capacitor element can be fixed more strongly in the outer case and hence the vibration resistance of the electrolytic capacitor can be increased.

In the electrolytic capacitor according to the invention, the capacitor element is fixed by a fixing plate which is inserted between the capacitor element and the internal bottom surface of the outer case and has approximately the same shape as the internal bottom surface of the outer case.

With this configuration, since the fixing plate is inserted so as to be placed on the internal bottom surface of the outer case, the interval between the fixing plate and the sealing member which press-fix the capacitor element does not increase though a pressure valve formed in the bottom surface of the outer case bulges out when the pressure valve bulges out due to increase of the internal pressure while the electrolytic capacitor is used. Therefore, the electrolytic capacitor can continue to be press-fixed at a prescribed pressure.

In the electrolytic capacitor according to the invention, the fixing plate has one or more through-holes.

With this configuration, when the internal pressure has increased due to a gas generated inside the electrolytic capacitor, the generated gas can pass through the through-hole(s) of the fixing plate. Since the pressure can directly act on the pressure valve which is formed in the bottom surface of the outer case, the function of the pressure valve is not impaired.

In the electrolytic capacitor according to the invention, at least a surface, located on a side of the capacitor element, of the fixing plate is covered with an insulating member.

With this configuration, in a state that the capacitor element is pressed against the fixing plate, the electrode foils do not come into direct contact with the metal fixing plate. Therefore, short-circuiting between the fixing plate and the electrode foils can be prevented.

In the electrolytic capacitor according to the invention, at least one surface of the fixing plate is covered with a vibration absorbing member.

With this configuration, vibration that is applied to the electrolytic capacitor is not directly transmitted to the capacitor element. Therefore, vibration that is received by the capacitor element can be reduced and hence the vibration resistance of the electrolytic capacitor can be increased.

In the electrolytic capacitor according to the invention, the fixing plate has an urging force for pressing the capacitor element.

With this configuration, when the fixing plate and the capacitor element are sealed in the outer case, the urging force of the fixing plate presses the capacitor element, whereby the capacitor element can be fixed more strongly and this state can be maintained. This makes it possible to provide an electrolytic capacitor which can well endure even strong vibration applied to it with the capacitor element kept fixed.

In the electrolytic capacitor according to the invention, the capacitor element has a plurality of separators and at least one of the separators is greater in width than the other separators and projects toward the internal bottom surface of the outer case.

With this configuration, when the capacitor element is pressed between the sealing member and the outer case or between the sealing member and the fixing plate, the projected portion of the wider separator is compressed to a prescribed dimension and the capacitor element is shaped so as to have a prescribed length. Thus, the capacitor element can be fixed more strongly and hence the vibration resistance of the electrolytic capacitor can be increased further.

According to the invention, in a method for manufacturing an electrolytic capacitor in which a capacitor element obtained by winding electrode foils with a separator therebetween and winding a winding stop tape on an outer circumferential surface thereof to stop the winding is housed in an outer case, and the outer case is sealed by a sealing member, a width of the winding stop tape is greater than or equal to a width of the electrode foils, and an open end portion of the outer case is sealed in a state that the capacitor element is pressed by an internal bottom surface of the outer case and the sealing member.

With this method, in the winding-type electrolytic capacitor, since the capacitor element is winding-stopped and fixed by the winding stop tape whose width is greater than or equal to the width of the electrode foils, the capacitor element does not bulge out or unwind even if the capacitor element is pressed at a prescribed pressure in the outer case. Therefore, the capacitor element can be press-fixed by applying a prescribed pressure to it. As a result, the capacitor element can be fixed more strongly in the outer case and hence the vibration resistance of the electrolytic capacitor can be increased.

### Advantage of the Invention

The invention makes it possible to fix the capacitor element strongly in the outer case without causing a short-circuit failure in the electrolytic capacitor or adversely affecting its electrical characteristics and hence can provide an electrolytic capacitor which is increased in vibration resistance.

### BRIEF DESCRIPTION OF THE DRAWINGS

FIG. 1 is a partially exploded perspective view of a capacitor element according to Example of the invention.

FIG. 2 is a sectional view showing the internal structure of an electrolytic capacitor according to Example of the invention.

FIG. 3 is a sectional view showing the internal structure of an electrolytic capacitor according to another Example of the invention in which a fixing plate is covered with an insulating member.

FIG. 4 is a sectional view showing the internal structure of an electrolytic capacitor according to a modification of the invention.

FIG. 5 is a partially cut-away perspective view of a conventional electrolytic capacitor.

### MODE FOR CARRYING OUT THE INVENTION

An electrolytic capacitor according to Example of the present invention will be hereinafter described in detail.

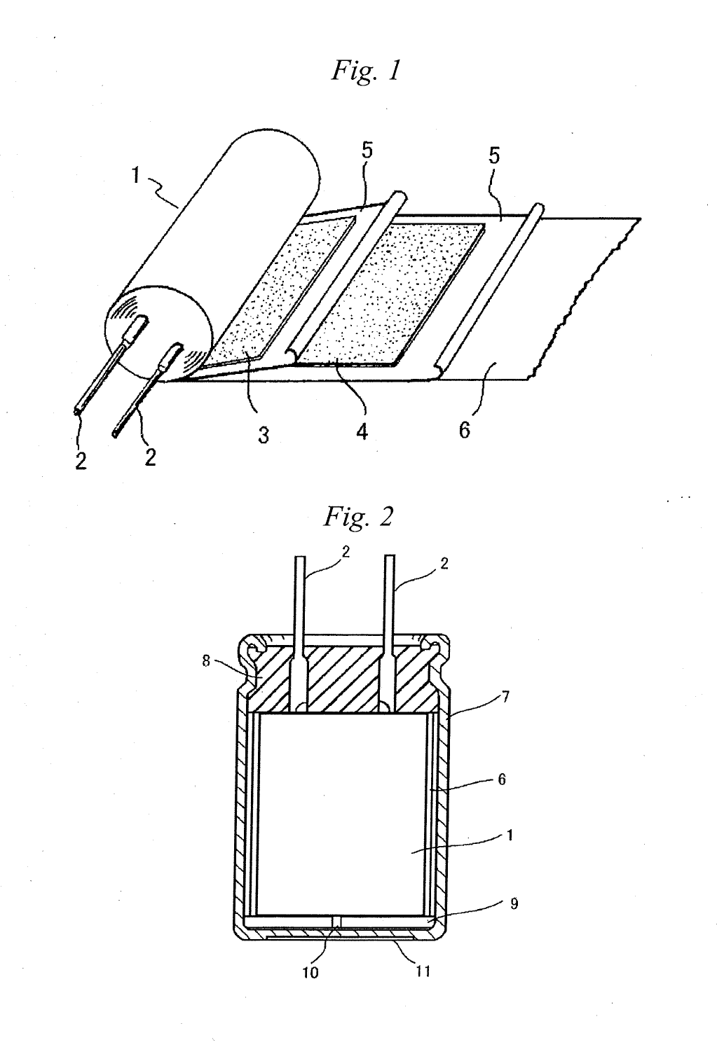

FIG. 1 is a partially exploded perspective view showing the structure of a capacitor element according to the invention. FIG. 2 is a sectional view showing the internal structure of the electrolytic capacitor according to the invention.

### EXAMPLES

As shown in FIG. 1, in the capacitor element 1 used in Example, an anode foil 3 is an aluminum foil formed by surface roughening treatment by etching followed by formation of chemical conversion coatings. A cathode foil 4 includes an aluminum foil formed by surface roughening treatment by etching and optionally a chemical conversion coating is formed thereon. Intra-electrode terminals 2 such as lead terminals which are made of, for example, aluminum are connected to the electrode foils by stitching or cold welding. The capacitor element 1 is formed in the following manner. Separators 5 which are made of an insulative material such as insulative paper (made of plant fiber, regenerated fiber, synthetic fiber, chemical fiber, or the like), nonwoven fabric, or mixed paper thereof are sandwiched between the anode foil 3 and the cathode foil 4, and the resulting structure is wound into a cylindrical shape. A winding end portion is fixed by a winding stop tape 6 to prevent its unwinding. The capacitor element 1 is housed in an aluminum outer case 7 which is shaped like a closed-bottom cylinder together with a drive electrolyte solution. An open end portion of the outer case 7 is provided with a sealing member 8 made of an elastic rubber, for example, and the electrolytic capacitor is sealed by caulking the open end portion by curling.

The winding stop tape 6 of the capacitor element 1 will be described below in detail. The winding stop tape 6 is wound on the outer circumferential surface of the capacitor element 1, thereby preventing unwinding of the capacitor element 1. It is preferable that the width of the winding stop tape 6 which is wound on the outer circumferential surface of the capacitor element 1 be at least greater than or equal to the width of the anode foil 3 which is wide and strong, and may be greater than or equal to the width of the capacitor element 1.

It is preferable that the winding stop tape 6 be wound on the outer circumferential surface of the capacitor element 1 by one turn or more to enable its winding end to be joined to itself, and that at least an approximately-half-turn portion of the winding stop tape 6 be joined and fixed to itself. In the case of a winding stop tape that is narrower than the electrode foils, it may be wound by plural turns so as to produce a total width that is greater than or equal to the width of the electrode foils. Or a single, narrow winding stop tape may be wound spirally so as to cover the entire outer circumferential surface of the capacitor element. In this Example, a polyphenylene sulfide tape which was about 50 μm in thickness and had the same width as the capacitor element 1 was used as the winding stop tape 6 and was wound on the outer circumferential surface of the capacitor element 1 by two turns to stop the winding.

Examples of materials for the winding stop tape 6 include a resin tape and rubber tape such as polyphenylene sulfide, polyethylene terephthalate, polypropylene, an ethylene-propylene terpolymer, polyethylene naphthalate; an insulative electrolytic paper; and a metal tape such as aluminum.

The width of the separators 5 used in the capacitor element 1 is set greater than or equal to the winding width of the anode foil 3 or the cathode foil 4. This can prevent an event that the anode foil 3 and the cathode foil 4 come close to each other and are short-circuited with each other or the anode foil 3 or the cathode foil 4 is short-circuited with the outer case 7 or a fixing plate 9 when the capacitor element 1 is pressed against and fixed to the internal bottom surface of the outer case 7.

Although in this Example the two separators used have the same width, one separator may be made wider than the other separator and may project toward the internal bottom surface of the outer case 7. In this case, when press-fixed, the wider separator is bent and comes to cover the foil end surface of one of the anode foil and the cathode foil. This is effective in preventing short-circuiting of the capacitor element and improving the withstand voltage characteristic.

In the capacitor element 1, the anode foil 2 and the cathode foil 3 are wound with the separators sandwiched therebetween. In a winding start portion of the capacitor element 1, only the separators may be wound by plural turns to form an electrodeless winding portion, which can increase the strength of the capacitor element 1. Instead of the electrodeless winding portion, a cylindrical member made of a resin material, for example, may be provided in a winding start portion.

Then, as shown in FIG. 2, a fixing plate 9 which has approximately the same shape as the internal bottom surface of the outer case 7 is housed in the outer case 7 on its internal bottom surface. The end surface of the capacitor element 1 is brought into contact with the top surface of the fixing plate 9 and the capacitor element 1 is inserted into the outer case 7 while prescribed pressing force is exerted on the sealing member 8, and the capacitor element 1 is fixed to the outer case 7. As a result, the capacitor element 1 is brought into a state that it is pressed by the internal bottom surface of the outer case 7 and the sealing member 8. In this state, the outer case 7 is sealed by caulking its open end portion with pressing forces exerted on the capacitor element 1. As for the caulking method, lateral caulking of caulking that portion of side wall of the outer case 7 which faces the sealing member 8 is performed first and a state that prescribed pressing forces are exerted on the capacitor element 1 is maintained. Then, longitudinal caulking of caulking the open end portion of the outer case 7 is performed, whereby the outer case 7 is sealed. Numeral 11 denotes a pressure valve which is cut grooves.

The fixing plate 9 which serves for fixing of the capacitor element 1 is made of a metal material such as aluminum and is shaped like a circular disk. It is necessary that the fixing plate 9 be strong enough to be kept flat when the capacitor element 1 is press-fixed. Even if the internal pressure is increased and the pressure valve bulges out while the electrolytic capacitor is used, the fixing plate 9 remains on the internal bottom surface of the outer case 7 and the interval between the sealing member 8 and the fixing plate 9 is not increased. Thus, the capacitor element 1 can continue to be press-fixed while receiving the prescribed pressing forces.

The fixing plate 9 may be made of any metal material that is not corroded by the drive electrolyte solution. Aluminum is particularly preferable.

A degassing through-hole is formed through the fixing plate 9. The through-hole 10 may have any size as long as it can pass a gas generated inside the electrolytic capacitor. Since the internal pressure of the electrolytic capacitor that has been increased by that gas can directly act on the pressure valve which is formed in the internal bottom surface of the outer case 7, the function of the pressure valve 11 is prevented from being impaired. Since the end surface of the capacitor element 1 is in contact with the fixing plate 9, no limitations are imposed on the size and the number of through-holes 10 as long as the end surface of the capacitor element 1 suffers no trouble such as damaging. Although in this Example one through-hole 10 is formed at the center, a plurality of through-holes 10 may be provided at arbitrary positions. The shape of the through-hole 10 may be any of a circle, a polygon, and a slit, and no limitations are imposed on the shape of the through-hole 10 as long as the through-hole 10 allows internal pressure to directly act on the internal bottom surface of the outer case 7.

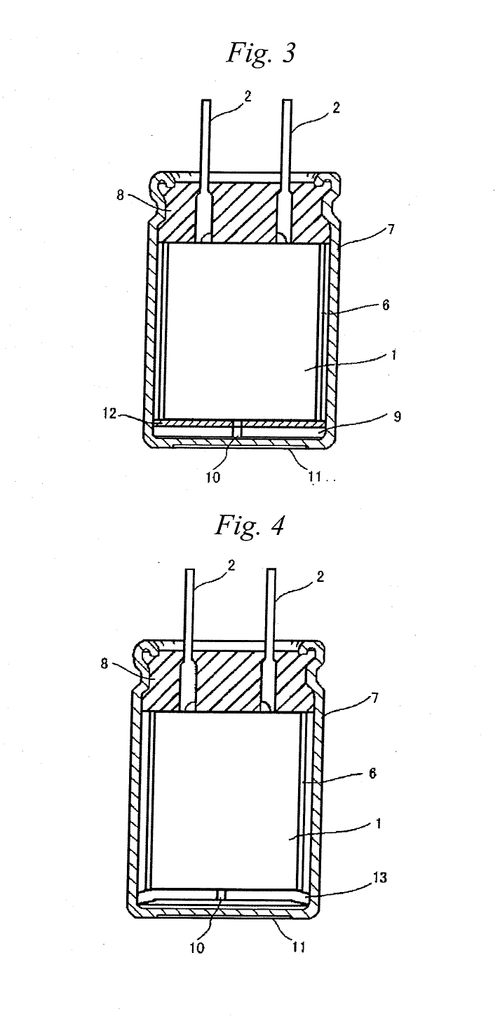

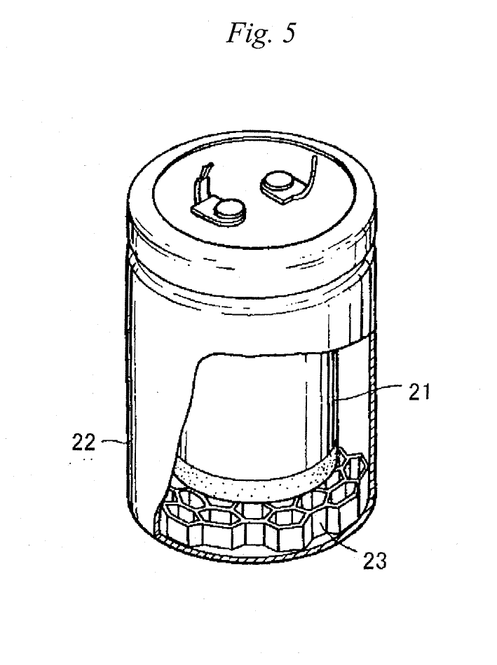

It is preferable that an insulating member 12 which covers the fixing plate 9 as shown in FIG. 3 be made of a heat-resistant resin or ceramic that is not deformed or softened by heat that is generated while the electrolytic capacitor is used. An event that the electrode foils come into contact with and are short-circuited with the metal fixing plate 9 can be prevented by sticking the insulating member 12 to at least the capacitor-element-side surface of the fixing plate 9.

A vibration absorbing member may be provided in place of the insulating member 12 so as to cover the fixing plate 9. It is preferable that the absorbing member be made of a heat-resistant rubber that is not corroded by the drive electrolyte solution and does not soften rapidly even at a high temperature. For example, a butyl rubber which absorbs vibration is particularly preferable.

In the present invention, although the insulating member 12 and the vibration absorbing member are disposed between the capacitor element 1 and the fixing plate 9, the vibration absorbing member may be disposed between the internal bottom surface of the outer case 7 and the fixing plate 9 or on both of the top and bottom surfaces of the fixing plate 9.

Next, a modification of the invention will be described in detail with reference to FIG. 4. FIG. 4 is a sectional view of an electrolytic capacitor according to the modification of the invention.

In this modification, as shown in FIG. 4, a fixing plate 13 is disposed between the capacitor element 1 and the outer case 7. The fixing plate 13 is a dish-shaped plate member which has convex toward one side before it is inserted into the outer case 7. The fixing plate 13 is fixed being confined in the outer case in a state that it is approximately flat because of pressure that is exerted from the capacitor element 1. The fixing plate 13 provides urging force for pressing the capacitor element 1 toward the sealing member at a constant pressure because the fixing plate 13 has ability to restore its original convex shape.

Therefore, even when the electrolytic capacitor receives strong vibration, the electrolytic capacitor can endure such a vibration. Even if wound-up capacitor elements have a dimensional variation in their longitudinal direction, the variation can be reduced to allow the capacitor elements to be press-fixed strongly. Thus, a superior electrolytic capacitor can be provided which can well endure vibratory stress that will occur in the vehicular use.

Another method for giving the fixing plate ability to produce urging force for pressing the capacitor element is as follows. An urging means such as a coil spring or a leaf spring is attached to the fixing plate to cause the fixing plate to urge the capacitor element.

### DESCRIPTION OF REFERENCE NUMERALS AND SIGNS

1: Capacitor element
2: Lead terminal
3: Anode foil
4: Cathode foil
5: Separator
6: Winding stop tape
7: Outer case
8: Sealing member
9: Fixing plate
10: Through-hole
11: Pressure valve
12: Insulating member
13: Convex fixing plate

1. An electrolytic capacitor in which a capacitor element obtained by winding electrode foils with a separator therebetween and winding a winding stop tape on an outer circumferential surface thereof to stop the winding is inserted in an outer case, and the outer case is sealed with a sealing member,
wherein a width of the winding stop tape is greater than or equal to a width of the electrode foils, and
the capacitor element is press-fixed by an internal bottom surface of the outer case and the sealing member.

2. The electrolytic capacitor according to claim 1, wherein the capacitor element is fixed by a fixing plate which is inserted between the capacitor element and the internal bottom surface of the outer case and has approximately the same shape as the internal bottom surface of the outer case.

3. The electrolytic capacitor according to claim 2, wherein the fixing plate has one or more through-holes.

4. The electrolytic capacitor according to claim 3, wherein at least a surface, located on a side of the capacitor element, of the fixing plate is covered with an insulating member.

5. The electrolytic capacitor according to claim 2, wherein at least one surface of the fixing plate is covered with a vibration absorbing member.

6. The electrolytic capacitor according to claim 2, wherein the fixing plate has an urging force for pressing the capacitor element.

7. The electrolytic capacitor according to claim 1, wherein the capacitor element has a plurality of separators, and at least one of the separators is greater in width than the other separators and projects toward the internal bottom surface of the outer case.

8. A method for manufacturing an electrolytic capacitor in which a capacitor element obtained by winding electrode foils with a separator therebetween and winding a winding stop tape on an outer circumferential surface thereof to stop the winding is housed in an outer case, and the outer case is sealed with a sealing member,
wherein a width of the winding stop tape is greater than or equal to a width of the electrode foils, and
an open end portion of the outer case is sealed in a state that the capacitor element is pressed by an internal bottom surface of the outer case and the sealing member.
